(19) United States
(12) Patent Application Publication
(10) Pub. No.: US 2023/0335080 A1
(43) Pub. Date: Oct. 19, 2023

(54) METHOD, APPARATUS AND DEVICE FOR GAMMA DEBUGGING

(71) Applicant: KunShan Go-Visionox Opto-Electronics Co., Ltd, Kunshan (CN)

(72) Inventors: Haozhi NIU, Kunshan (CN); Tiegang WANG, Kunshan (CN); Guangguang HAN, Kunshan (CN); Haibin JIANG, Kunshan (CN); Xiuning SHANGGUAN, Kunshan (CN)

(73) Assignee: KunShan Go-Visionox Opto-Electronics Co., Ltd, Kunshan (CN)

(21) Appl. No.: 18/341,044

(22) Filed: Jun. 26, 2023

Related U.S. Application Data
(63) Continuation of application No. PCT/CN2021/124554, filed on Oct. 19, 2021.

(30) Foreign Application Priority Data
Jan. 28, 2021 (CN) 202110120573.8

(51) Int. Cl. G09G 5/10; G09G 3/00

(52) U.S. Cl. CPC G09G 5/10; G09G 3/006; G09G 2320/0276; G09G 2320/0626; G09G 2320/0673

(57) ABSTRACT

A method for gamma debugging, an apparatus for gamma debugging and a device for gamma debugging. The method includes: acquiring a first voltage difference value between a first gray scale binding point and a second gray scale binding point of a first display panel at a first brightness level; performing gamma debugging on a second display panel at the first brightness level, to determine a voltage value corresponding to the first gray scale binding point of the second display panel at the first brightness level; and taking a difference between the voltage value corresponding to the first gray scale binding point of the second display panel at the first brightness level and the first voltage difference value as a first initial voltage value, to perform gamma debugging on the second display panel at the second gray scale binding point at the first brightness level.

### CROSS-REFERENCE TO RELATED APPLICATIONS

This application is a continuation of International Application No. PCT/CN2021/124554, filed on Oct. 19, 2021, which claims priority to Chinese Patent Application No. 202110120573.8, entitled “Method, apparatus and device for gamma debugging”, filed on Jan. 28, 2021, both of which are hereby incorporated by reference in their entireties.

### TECHNICAL FIELD

The present application relates to the technical field of display, and in particular to a method for gamma debugging, an apparatus for gamma debugging and a device for gamma debugging.

### BACKGROUND

Gamma debugging is typically performed on each display panel before it is shipped from the factory. At present, a method for performing gamma debugging on a display panel is to set a voltage value corresponding to each gray scale binding point according to experience, and if the set voltage value is inaccurate, the voltage value corresponding to each gray scale binding point needs to be continuously adjusted until an optical parameter such as brightness and color coordinate of each gray scale binding point reach a corresponding target value. However, at present, the number of gray scale binding points of each display panel is generally up to several tens, and gamma debugging is required at different brightness levels, and each gray scale binding point often requires multiple adjustments, so the time for gamma debugging is very long, affecting the production efficiency.

### SUMMARY

A first aspect of the present application provides a method for gamma debugging, which includes: acquiring a first voltage difference value between a first gray scale binding point and a second gray scale binding point of a first display panel at a first brightness level; performing gamma debugging on a second display panel at the first brightness level, to determine a voltage value corresponding to the first gray scale binding point of the second display panel at the first brightness level; and taking a difference between the voltage value corresponding to the first gray scale binding point of the second display panel at the first brightness level and the first voltage difference value as a first initial voltage value, to perform gamma debugging on the second display panel at the second gray scale binding point at the first brightness level.

A second aspect of the present application provides an apparatus for gamma debugging, which includes: a voltage difference value acquisition module configured to acquire a first voltage difference value between a first gray scale binding point and a second gray scale binding point of a first display panel at a first brightness level; a voltage value determination module configured to perform gamma debugging on a second display panel at the first brightness level, to determine a voltage value corresponding to the first gray scale binding point of the second display panel at the first brightness level; a debugging module configured to take a difference between the voltage value corresponding to the first gray scale binding point of the second display panel at the first brightness level and the first voltage difference value as a first initial voltage value, to perform gamma debugging on the second display panel at the second gray scale binding point at the first brightness level.

A third aspect of the present application provides a device for gamma debugging, which includes a processor, a memory, and a computer program stored on the memory and executable on the processor, wherein the computer program, when executed by the processor, implements the method for gamma debugging of any one of the embodiments of the first aspect.

### BRIEF DESCRIPTION OF THE DRAWINGS

Other features, objects, and advantages of the present application will become more apparent from the following detailed description of non-limiting embodiments with reference to the accompanying drawings, wherein same or similar reference numbers refer to same or similar features, and the drawings are not drawn to an actual scale.

FIG. 1 illustrates a schematic flow diagram of a method for gamma debugging according to an embodiment of the present application;

FIG. 2 illustrates a schematic flow diagram of a method for gamma debugging according to another embodiment of the present application;

FIG. 3 illustrates a schematic flow diagram of a method for gamma debugging according to yet another embodiment of the present application;

FIG. 4 illustrates a schematic flow diagram of a method for gamma debugging according to yet another embodiment of the present application;

FIG. 5 illustrates a schematic flow diagram of a method for gamma debugging according to yet another embodiment of the present application;

FIG. 6 illustrates a schematic diagram of brightness levels and gray scale binding points according to an embodiment of the present application;

FIG. 7 illustrates a schematic flow diagram of a method for gamma debugging according to yet another embodiment of the present application;

FIG. 8 illustrates a schematic diagram of gamma debugging time according to an embodiment of the present application;

FIG. 9 illustrates a schematic structural diagram of an apparatus for gamma debugging according to an embodiment of the present application;

FIG. 10 illustrates a schematic structural diagram of an apparatus for gamma debugging according to another embodiment of the present application;

FIG. 11 illustrates a schematic structural diagram of a device for gamma debugging according to an embodiment of the present application.

### DETAILED DESCRIPTION

Features and exemplary embodiments of various aspects of the present application will be described in detail below, and in order to make the objects, technical solutions and advantages of the present application more apparent, detailed description of the present application will further be made in detail below in conjunction with the accompanying drawings and specific embodiments. It should be understood that the specific embodiments described herein are only configured to explain the present application, and are not configured to limit the present application. It will be apparent to one skilled in the art that the present application may be practiced without some of these specific details. The following description of the embodiments is merely provided to provide a better understanding of the present application by illustrating examples of the present application.

Embodiments of the present application provide a method for gamma debugging, an apparatus for gamma debugging and a device for gamma debugging, and embodiments of a method for gamma debugging, an apparatus for gamma debugging and a device for gamma debugging will be described below in conjunction with the accompanying drawings.

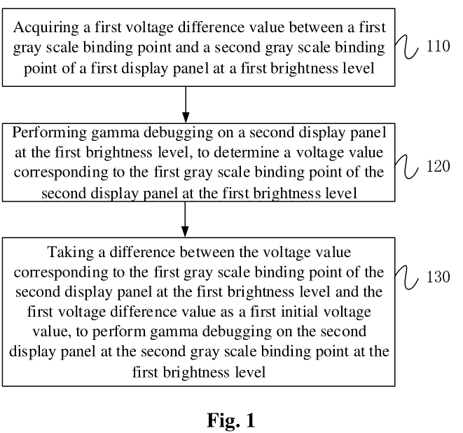

FIG. 1 illustrates a schematic flow diagram of a method for gamma debugging according to an embodiment of the present application. As shown in FIG. 1, the method for gamma debugging according to an embodiment of the present application includes steps 110 to 130.

At step 110, a first voltage difference value between a first gray scale binding point and a second gray scale binding point of a first display panel at a first brightness level is acquired.

At step 120, gamma debugging is performed on a second display panel at the first brightness level, to determine a voltage value corresponding to the first gray scale binding point of the second display panel at the first brightness level.

At step 130, a difference between the voltage value corresponding to the first gray scale binding point of the second display panel at the first brightness level and the first voltage difference value is taken as a first initial voltage value, to perform gamma debugging on the second display panel at the second gray scale binding point at the first brightness level.

According to the method for gamma debugging according to the embodiment of the present application, a first voltage difference value between a first gray scale binding point and a second gray scale binding point of a first display panel is acquired first, and when performing gamma debugging on a second display panel at a first brightness level, it is only necessary to determine a voltage value corresponding to the first gray scale binding point of the second display panel at the first brightness level, and a difference between the voltage value corresponding to the first gray scale binding point of the second display panel at the first brightness level and the first voltage difference value is taken as a first initial voltage value, to perform gamma debugging on the second display panel at the second gray scale binding point at the first brightness level. The first initial voltage value is closer to an actual voltage value corresponding to the second gray scale binding point of the second display panel at the first brightness level, and with respect to randomly setting an initial voltage value corresponding to the second gray scale binding point of the second display panel at the first brightness level, an assignment value according to the first initial voltage value is more accurate, so that the number of times of performing gamma debugging on the second display panel at the second gray scale binding point at the first brightness level can be reduced, thereby reducing gamma debugging time and improving production efficiency.

Illustratively, the first display panel and the second display panel may be display panels of the same batch. With respect to different batches of display panels, a voltage difference value of a previous display panel in the same batch of display panels has a higher reference significance for a next display panel.

Illustratively, both the first display panel and the second display panel are 8-bit display panels, i.e. both the first display panel and the second display panel have 256 levels of gray ranging from 0 to 255 levels. The first gray scale binding point and the second gray scale binding point may be any one of values from 0 to 255, it can be understood that the first gray scale binding point and the second gray scale binding point are different. For example, the first gray scale binding point has a gray scale of 255 and the second gray scale binding point has a gray scale of 250.

Illustratively, the first display panel and the second display panel each have a plurality of brightness levels, and different brightness levels correspond to different target brightness values at the same gray scale. For example, at a gray scale of 255, the target brightness corresponding to the first brightness level is 430nit and the target brightness corresponding to the second brightness level is 410nit. It will be appreciated that at the same gray scale, voltage values required for different brightness levels are also different.

Herein, a voltage value may be understood as a data voltage value required to be supplied by a driving chip, and the data voltage value is transmitted to sub-pixels of a display panel through a data line of the display panel, so that the sub-pixels generate a driving current and emit light. A voltage difference value may be understood as a difference in data voltage values.

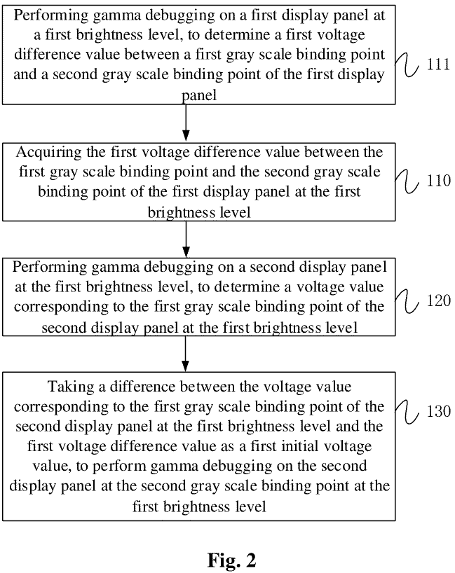

In some optional embodiments, as shown in FIG. 2, prior to step 110, the method for gamma debugging provided by embodiments of the present application may further include step 111: performing gamma debugging on the first display panel at the first brightness level, to determine the first voltage difference value between the first gray scale binding point and the second gray scale binding point of the first display panel.

Illustratively, the first voltage difference value determined in step 111 may be stored after step 111 and before step 110.

Illustratively, step 111 may specifically include: setting an initial voltage value V11 corresponding to the first gray scale binding point of the first display panel at the first brightness level and an initial voltage value V12 corresponding to the second gray scale binding point at the first brightness level; determining whether the actual brightness of the first display panel at the initial voltage value V11 complies with a target brightness value corresponding to the first gray scale binding point of the first display panel at the first brightness level, and determining whether the actual brightness of the first display panel at the initial voltage value V12 complies with a target brightness value corresponding to the second gray scale binding point of the first display panel at the first brightness level. If the actual brightness of the first display panel at the initial voltage value V11 does not comply with the target brightness value corresponding to the first gray scale binding point of the first display panel at the first brightness level, the numerical value of the initial voltage value V11 is adjusted until the actual brightness of the first display panel at the adjusted initial voltage value V11′ complies with the target brightness value corresponding to the first gray scale binding point of the first display panel at the first brightness level, and the adjusted initial voltage value V11′ is taken as an actual voltage value corresponding to the first gray scale binding point of the first display panel at the first brightness level. If the actual brightness of the first display panel at the initial voltage value V12 does not comply with the target brightness value corresponding to the second gray scale binding point of the first display panel at the first brightness level, the numerical value of the initial voltage value V12 is adjusted until the actual brightness of the first display panel at the adjusted initial voltage value V12′ complies with the target brightness value corresponding to the second gray scale binding point of the first display panel at the first brightness level, and the adjusted initial voltage value V12′ is taken as an actual voltage value corresponding to the second gray scale binding point of the first display panel at the first brightness level. A difference value between the adjusted initial voltage value V11′ and the adjusted initial voltage value V12′ is taken as the first voltage difference value.

It can be understood that if the actual brightness of the first display panel at the initial voltage value V11 complies with the target brightness value corresponding to the first gray scale binding point of the first display panel at the first brightness level, the initial voltage value V11 can be directly used as the actual voltage value corresponding to the first gray scale binding point of the first display panel at the first brightness level. If the actual brightness of the first display panel at the initial voltage value V12 complies with the target brightness value corresponding to the second gray scale binding point of the first display panel at the first brightness level, the initial voltage value V12 can be directly used as the actual voltage value corresponding to the second gray scale binding point of the first display panel at the first brightness level. Further, a difference value between the initial voltage value V11 and the initial voltage value V12 may be used as the first voltage difference value.

Illustratively, a voltage value corresponding to the first gray scale binding point of the second display panel at the first brightness level in step 120 may be determined in the manner described above for determining the actual voltage value corresponding to the first gray scale binding point of the first display panel at the first brightness level in step 111, which will not be described in detail herein. It will be appreciated that an actual brightness value at the voltage value corresponding to the first gray scale binding point of the second display panel at the first brightness level complies with a target brightness value corresponding to the first gray scale binding point of the second display panel at the first brightness level.

In some optional embodiments, step 130 may specifically include: taking a difference between the voltage value corresponding to the first gray scale binding point of the second display panel at the first brightness level and the first voltage difference value as the first initial voltage value, to perform gamma debugging on the second display panel at the second gray scale binding point at the first brightness level, so as to determine an actual voltage value corresponding to the second gray scale binding point of the second display panel at the first brightness level. Illustratively, the actual voltage value corresponding to the second gray scale binding point of the second display panel at the first brightness level in step 130 may be determined in the manner described above for determining the actual voltage value corresponding to the first gray scale binding point of the first display panel at the first brightness level in step 111, which will not be described in detail herein. It can be understood that the first initial voltage value is an initial voltage value corresponding to the second gray scale binding point of the second display panel at the first brightness level, and an actual brightness value at the actual voltage value corresponding to the second gray scale binding point of the second display panel at the first brightness level complies with a target brightness value corresponding to the second gray scale binding point of the second display panel at the first brightness level.

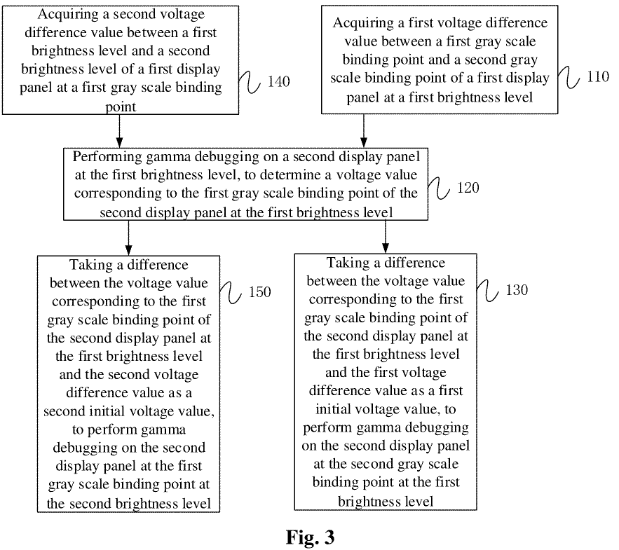

In some optional embodiments, as shown in FIG. 3, before step 120, the method for gamma debugging provided by embodiments of the present application may further include step 140, and after step 120, the method for gamma debugging provided by embodiments of the present application may further include step 150.

At step 140, a second voltage difference value between the first brightness level and the second brightness level of the first display panel at the first gray scale binding point is acquired.

At step 150, a difference between the voltage value corresponding to the first gray scale binding point of the second display panel at the first brightness level and the second voltage difference value is taken as a second initial voltage value, to perform gamma debugging on the second display panel at the first gray scale binding point at the second brightness level.

According to embodiments of the present application, the second voltage difference value between the first brightness level and the second brightness level of the first display panel is acquired first, it is only necessary to determine the voltage value corresponding to the first gray scale binding point of the second display panel at the first brightness level, and to take the difference between the voltage value corresponding to the first gray scale binding point of the second display panel at the first brightness level and the second voltage difference value as the second initial voltage value, and then gamma debugging is performed on the second display panel at the first gray scale binding point at the second brightness level. The second initial voltage value is closer to the actual voltage value corresponding to the first gray scale binding point of the second display panel at the second brightness level, and with respect to randomly setting an initial voltage value corresponding to the first gray scale binding point of the second display panel at the second brightness level, an assignment value according to the second initial voltage value is more accurate, so that the number of times of performing gamma debugging on the second display panel at the first gray scale binding point at the second brightness level can be reduced, thereby reducing gamma debugging time and improving production efficiency.

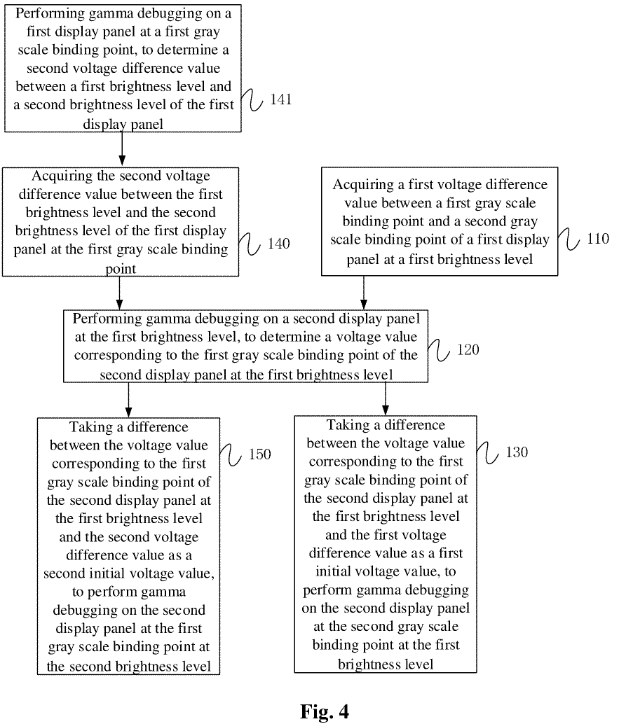

In some optional embodiments, as shown in FIG. 4, prior to step 140, the method for gamma debugging provided by embodiments of the present application may further include step 141: performing gamma debugging on the first display panel at the first gray scale binding point, to determine the second voltage difference value between the first brightness level and the second brightness level of the first display panel.

Illustratively, the second voltage difference value of the first display panel in step 141 may be determined in the manner described above for determining the first voltage difference value of the first display panel in step 111, which will not be described in detail herein.

Illustratively, after step 141 and before step 140, the second voltage difference value determined in step 141 may also be stored.

In some optional embodiments, step 150 may specifically include: taking a difference between the voltage value corresponding to the first gray scale binding point of the second display panel at the first brightness level and the second voltage difference value as the second initial voltage value, to perform gamma debugging on the second display panel at the first gray scale binding point at the second brightness level, so as to determine the actual voltage value corresponding to the first gray scale binding point of the second display panel at the second brightness level. Illustratively, the actual voltage value corresponding to the first gray scale binding point of the second display panel at the second brightness level in step 150 may be determined in the manner described above for determining the actual voltage value corresponding to the first gray scale binding point of the first display panel at the first brightness level in step 111, which will not be described in detail herein. It can be understood that the second initial voltage value is an initial voltage value corresponding to the first gray scale binding point of the second display panel at the second brightness level, and an actual brightness value at the voltage value corresponding to the first gray scale binding point of the second display panel at the second brightness level complies with a target brightness value corresponding to the first gray scale binding point of the second display panel at the second brightness level.

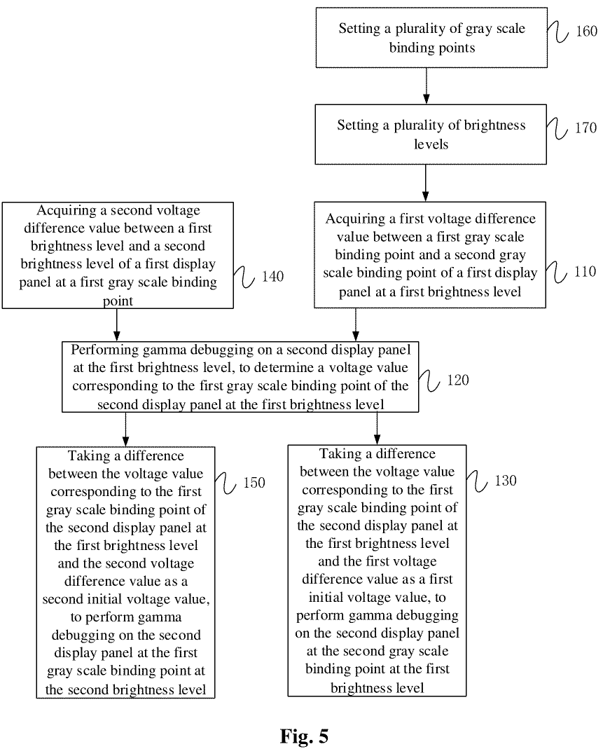

In some optional embodiments, as shown in FIG. 5, prior to step 110, the method for gamma debugging provided by embodiments of the present application may further include step 160.

At step 160, a plurality of gray scale binding points are set, wherein the first gray scale binding point and the second gray scale binding point are two adjacent gray scale binding points in the plurality of gray scale binding points.

Illustratively, still taking the example that the first display panel and the second display panel are both 8-bit display panels, some numerical values from 0-255 may be selected as gray scale binding points. For example, gray scale binding points may include a gray scale of 0, a gray scale of 32, a gray scale of 64, a gray scale of 96, a gray scale of 128, a gray scale of 160, a gray scale of 192, a gray scale of 224, a gray scale of 255. For example, the first gray scale binding point has a gray scale of 32, and the second gray scale binding point may have a gray scale of 0 or a gray scale of 64. For example, the first gray scale binding point has a gray scale of 128, and the second gray scale binding point may have a gray scale of 160 or a gray scale of 96.

Of course, the number of the gray scale binding points and the specific numerical values of the gray scale binding points may be set to be different from the above-mentioned examples, which are not limited in the present application.

Since a value of a data voltage does not increase linearly with the increase of a gray scale, and the display panel is very sensitive to the change of the data voltage, by taking two adjacent gray scale binding points among the plurality of gray scale binding points as the first gray scale binding point and the second gray scale binding point, the difference value between the first gray scale binding point and the second gray scale binding point can be avoided to be too large, and the first voltage difference value can be avoided to lose the reference significance, so as to further ensure that the assignment value according to the first initial voltage value is more accurate, and then the number of times of performing gamma debugging on the second display panel at the second gray scale binding point at the first brightness level can be reduced, thereby reducing gamma debugging time and improving production efficiency.

In some optional embodiments, with continued reference to FIG. 5, prior to step 110, the method for gamma debugging provided by embodiments of the present application may further include step 170.

At step 170, a plurality of brightness levels are set, wherein the first brightness level and the second brightness level are two adjacent brightness levels selected from the plurality of brightness levels.

Illustratively, a brightness adjustment control, usually a brightness adjustment bar, is set on the display panel, and the brightness adjustment bar is slid to present a same picture with different brightness. The brightness levels may correspond to different positions of the brightness adjustment bars.

Illustratively, the plurality of brightness levels may include a highest brightness level and a lowest brightness level, as well as other brightness levels between the highest brightness level and the lowest brightness level. For example, the number of brightness levels may be 10, and of course, the number of brightness levels and the target brightness value corresponding to each brightness level may be set according to actual requirements, and this is not limited in the present application.

As stated above, since a value of a data voltage does not increase linearly with the increase of a gray scale, and the display panel is very sensitive to the change of the data voltage, by taking two adjacent brightness levels in the plurality of brightness levels as the first brightness level and the second brightness level, it is possible to avoid the difference value between the first brightness level and the second brightness level being too large at the same gray scale, and to avoid the second voltage difference value losing reference significance, so as to further ensure that the assignment value according to the second initial voltage value is more accurate, and thus the number of times of performing gamma debugging on the second display panel at the first gray scale binding point at the second brightness level can be reduced, thereby reducing gamma debugging time and improving production efficiency.

In some optional embodiments, the target brightness value corresponding to the first gray scale binding point is greater than the target brightness value corresponding to the second gray scale binding point. At the same gray scale binding point, the target brightness value corresponding to the first brightness level is greater than the target brightness value corresponding to the second brightness level.

When performing gamma debugging on a display panel, debugging can be performed according to a certain order of brightness levels and a certain order of gray scale binding points. Due to the limitation of a brightness acquisition device, an acquisition accuracy at low brightness is not higher than that at high brightness, therefore, gamma debugging can be performed in the order of gradually decreasing the target brightness corresponding to brightness levels and gradually decreasing the gray scale binding points, and a voltage difference value of the first display panel at high brightness level and high gray scale is referred to so as to make an initial voltage reference value more accurate, thereby reducing the time for performing gamma debugging on the second display panel at low brightness level and low gray scale.

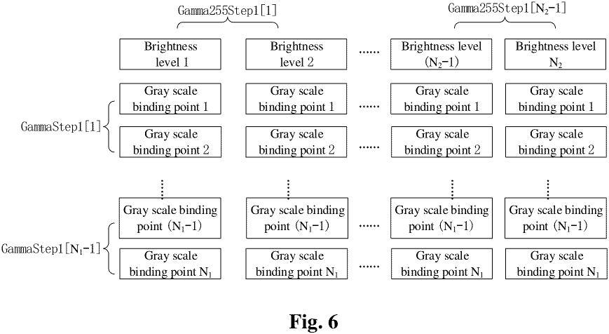

In order to more clearly understand the present application, as an example, as shown in FIG. 6, the number of gray scale binding points can be set as N₁, and a plurality of gray scale binding points are respectively a gray scale binding point 1 to a gray scale binding point N₁, wherein gray scale values corresponding to the gray scale binding point 1 to the gray scale binding point N₁ can be successively decreased. Illustratively, the gray scale binding point 1 may have a gray scale of 255. In addition, the number of brightness levels may be set to N₂, a plurality of brightness levels are respectively a brightness level 1 to a brightness level N₂, and the target brightness values corresponding to the brightness level 1 to the brightness level N₂ may be successively decreased at the same gray scale. Illustratively, the brightness level 1 may be a brightness level corresponding to a High Brightness Mode (HBM), and brightness levels 2 through N2 may be brightness levels corresponding to a Normal Mode.

Illustratively, an actual voltage value corresponding to each gray scale binding point at each brightness level in FIG. 6 can be determined in the above-mentioned manner of determining the actual voltage value corresponding to the first gray scale binding point of the first display panel at the first brightness level in step 111; then in the manner described above for determining the first voltage difference value in step 111, a first voltage difference value between adjacent gray scale binding points at each brightness level in FIG. 6 is determined and a second voltage difference value between adjacent brightness levels at each gray scale binding point in FIG. 6 is determined.

As described above, gamma debugging may be performed on the first display panel in the order that the target brightness corresponding to brightness levels gradually decreases and the gray scale binding points gradually decrease, and illustratively, the brightness level 1 is a maximum brightness level among the plurality of brightness levels and the gray scale binding point 1 is a gray scale binding point having a maximum gray scale among the plurality of gray scale binding points.

Specifically, at the brightness level 1, a first voltage difference value between adjacent gray scale binding points of the first display panel is determined and stored. Illustratively, at the brightness level 1, a first voltage difference value between the gray scale pinning point 1 and the gray scale pinning point 2 is stored as GammaStep1[1], a first voltage difference value between the gray scale pinning point 2 and the gray scale pinning point 3 is stored as GammaStep1[2], and so on, a first voltage difference value between the gray scale pinning point (N₁-1) and the gray scale pinning point N₁ is stored as GammaStep1[N₁-1].

At each gray scale binding point, a second voltage difference value between adjacent brightness levels is determined and stored. Taking the gray scale binding point 1 as an example and taking an example that the gray scale binding point 1 has a gray scale of 255, at the gray scale binding point 1, a second voltage difference value between the brightness level 1 and the brightness level 2 is stored as Gamma255Step1[1], a second voltage difference value between the brightness level 2 and the brightness level 3 is stored as Gamma255Step1[2], and so on, a second voltage difference value between the brightness level (N₂-1) and the brightness level N₂ is stored as Gamma255Step1[N₂-1].

When performing gamma debugging on the second display panel, the gamma debugging is still performed in the order of gradually decreasing the target brightness corresponding to brightness levels and gradually decreasing the gray scale binding points. Specifically, gamma debugging is firstly performed on the gray scale binding point 1 of the second display panel at the brightness level 1, to determine a voltage value corresponding to the gray scale binding point 1 at the brightness level 1, and then a difference value between the voltage value corresponding to the gray scale binding point 1 at the brightness level 1 and GammaStep1[1] is taken as a first initial voltage value of the gray scale binding point 2 of the second display panel at the brightness level 1, to perform gamma debugging on the gray scale binding point 2 of the second display panel at the brightness level 1 using the first initial voltage value. Since the first initial voltage value is more accurate with respect to a randomly set initial voltage value, it is possible to quickly determine the actual voltage value corresponding to the gray scale binding points 2 of the second display panel at the brightness level 1. Furthermore, a difference value between the actual voltage value corresponding to the gray scale binding point 2 of the second display panel at the brightness level 1 and GammaStep1[2] is taken as the first initial voltage value of the gray scale binding point 3 of the second display panel at the brightness level 1, so as to determine the actual voltage value corresponding to the gray scale binding point 3 of the second display panel at the brightness level 1. By analogy, a difference value between the actual voltage value corresponding to the gray scale binding point (N ₁-1) of the second display panel at the brightness level 1 and GammaStep1[N₁-1] is taken as the first initial voltage value of the gray scale binding point N₁ of the second display panel at the brightness level 1, and then the actual voltage value corresponding to the gray scale binding point N₁ of the second display panel at the brightness level 1 is determined.

After performing debugging on the second display panel at the brightness level 1, debugging for the gray scale binding point 1 at other brightness levels can be performed as follows.

The voltage value corresponding to the gray scale binding point 1 of the second display panel at the brightness level 1 has been determined above, then a difference value between the voltage value corresponding to the gray scale binding point 1 of the second display panel at the brightness level 1 and Gamma255Step1[1] is taken as a second initial voltage value of the gray scale binding point 1 of the second display panel at the brightness level 2, to perform gamma debugging on the gray scale binding point 1 of the second display panel at the brightness level 2 using the second initial voltage value. Since the second initial voltage value is more accurate with respect to a randomly set initial voltage value, it is possible to quickly determine the actual voltage value corresponding to the gray scale binding point 1 of the second display panel at the brightness level 2. Furthermore, a difference value between the actual voltage value corresponding to the gray scale binding point 1 of the second display panel at the brightness level 2 and Gamma255Step1[2] is taken as the second initial voltage value of the gray scale binding point 1 of the second display panel at the brightness level 3, so as to determine the actual voltage value corresponding to the gray scale binding point 1 of the second display panel at the brightness level 3. By analogy, a difference value between the actual voltage value corresponding to the gray scale binding point 1 of the second display panel at the brightness level (N₂-1) and Gamma255Step1[N₂-1] is taken as the second initial voltage value of the gray scale binding point 1 of the second display panel at the brightness level N₂, and then the actual voltage value corresponding to the gray scale binding point 1 of the second display panel at the brightness level N₂ is determined.

By analogy, the actual voltage value corresponding to the gray scale binding point 2 to the gray scale binding point (N₁-1) at the brightness level 2 to the brightness level N₂ can be determined.

FIG. 6 is merely an example and is not intended to limit the present application.

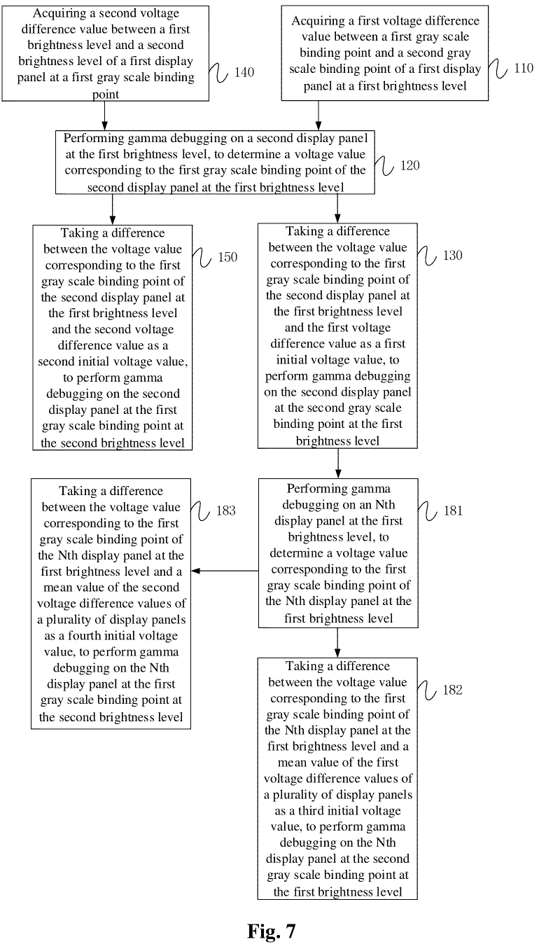

In some optional embodiments, as shown in FIG. 7, after step 130, the method for gamma debugging provided by embodiments of the present application may further include steps 181 through 182.

At step 181, gamma debugging is performed on an Nth display panel at the first brightness level, to determine a voltage value corresponding to the first gray scale binding point of the Nth display panel at the first brightness level, wherein N ≥ 3 and N is an integer.

At step 182, a difference between the voltage value corresponding to the first gray scale binding point of the Nth display panel at the first brightness level and a mean value of the first voltage difference values of a plurality of display panels is taken as a third initial voltage value, to perform gamma debugging on the Nth display panel at the second gray scale binding point at the first brightness level.

Even if each display panel belongs to the same batch, there is an inevitable difference in the characteristics for each display panel. When performing gamma debugging on a subsequent display panel, the influence of different characteristics of the display panels can be reduced as much as possible by taking a mean value determined by the first voltage difference value of each display panel for which gamma debugging has been completed previously as a reference, so as to more accurately assign an initial voltage value to the second gray scale binding point of the subsequent display panel at the first brightness level.

Illustratively, the mean value of the first voltage difference values of the plurality of display panels may be a mean value of respective first voltage difference values between the first gray scale binding point and the second gray scale binding point of the first display panel to the (N-1)th display panel at the first brightness level.

Illustratively, the voltage value corresponding to the first gray scale binding point of the Nth display panel at the first brightness level in step 181 may be determined in the above-mentioned manner of determining the actual voltage value corresponding to the first gray scale binding point of the first display panel at the first brightness level in step 111, which will not be described in detail herein. It can be understood that the actual brightness value at the voltage value corresponding to the first gray scale binding point of the Nth display panel at the first brightness level complies with the target brightness value corresponding to the first gray scale binding point of the Nth display panel at the first brightness level.

After the gamma debugging of the second display panel is completed, each first voltage difference value between the first gray scale binding point and the second gray scale binding point of the second display panel at the first brightness level can be obtained. Continuing with the example where the gray scale binding points comprises gray scale binding point 1 to gray scale binding point N1, each first voltage difference value between the first gray scale binding point and the second gray scale binding point of the second display panel at the first brightness level is stored as GammaStep2[i], wherein 1 ≤ i < (N₁-1). GammaStep2[1] represents a first voltage difference value between the gray scale binding point 1 and the gray scale binding point 2 of the second display panel at the brightness level 1, GammaStep2[2] represents a first voltage difference value between the gray scale binding point 2 and the gray scale binding point 3 of the second display panel at the brightness level 1, and so on.

Illustratively, the mean value of the first voltage difference values of the plurality of display panels in step 182 may be calculated according to equation (1):

$$\begin{matrix}\text{GammaStep} \left[\text{i}\right] = \\ \frac{\text{GammaStep1} \left[\text{i}\right] + \text{GammaStep2} \left[\text{i}\right] + ⋯ + \text{GammaStep} \left(\text{N} - 1\right) \left[\text{i}\right]}{\text{N} - 1}\end{matrix} \qquad \text{(1)}$$

wherein GammaStep[i] represents the mean value of the first voltage difference values of the plurality of display panels, and GammaStep(N-1)[i] represents each first voltage difference value between the first gray scale binding point and the second gray scale binding point of the (N-1)th display panel at the first brightness level.

In some optional embodiments, step 182 may specifically include: taking a difference between the voltage value corresponding to the first gray scale binding point of the Nth display panel at the first brightness level and the mean value of the first voltage difference values of the plurality of display panels as a third initial voltage value, to perform gamma debugging on the Nth display panel at the second gray scale binding point at the first brightness level, so as to determine an actual voltage value corresponding to the second gray scale binding point of the Nth display panel at the first brightness level. Illustratively, the actual voltage value corresponding to the second gray scale binding point of the Nth display panel at the first brightness level in step 182 may be determined in the manner described above for determining the actual voltage value corresponding to the first gray scale binding point of the first display panel at the first brightness level in step 111, which will not be described in detail herein. It can be understood that the actual brightness value at the actual voltage value corresponding to the second gray scale binding point of the Nth display panel at the first brightness level complies with the target brightness value corresponding to the second gray scale binding point of the Nth display panel at the first brightness level.

In order to better understand the present application, an example is given below. For example, the display panels to be debugged include a first display panel to a tenth display panel, and after performing gamma debugging on the first display panel and the second display panel, the mean value of the first voltage difference values of the first display panel and the second display panel can be determined according to the respective first voltage difference values between the first gray scale binding point and the second gray scale binding point of the first display panel and the second display panel at the first brightness level, and then the mean value of the first voltage difference values determined from the first display panel and the second display panel is used to determine an initial voltage value corresponding to the second gray scale binding point of a third display panel at the first brightness level, to perform gamma debugging on the third display panel, and then an initial voltage value corresponding to the second gray scale binding point of a fourth display panel at the first brightness level is determined using the mean value of the first voltage difference values determined from the first display panel to the third display panel, to perform gamma debugging on the fourth display panel, and so on, the mean value of the first voltage difference values determined from the first display panel to the ninth display panel is used to determine an initial voltage value corresponding to the second gray scale binding point of the tenth display panel at the first brightness level, to perform gamma debugging on the tenth display panel. That is to say, when performing gamma debugging on the third display panel and display panels subsequent to the third display panel in sequence, the initial voltage values corresponding to the second gray scale binding point at the first brightness level are all determined according to the mean values of the first voltage difference values determined from previous display panels for which the debugging has been completed.

In some optional embodiments, with continued reference to FIG. 7, after step 130, the method for gamma debugging provided by embodiments of the present application may further include step 183.

At step 183, a difference between the voltage value corresponding to the first gray scale binding point of the Nth display panel at the first brightness level and a mean value of the second voltage difference values of a plurality of display panels is taken as a fourth initial voltage value, to perform gamma debugging on the Nth display panel at the first gray scale binding point at the second brightness level.

As described above, even if each display panel belongs to the same batch, there is an inevitable difference in the characteristics for each display panel. When performing gamma debugging on a subsequent display panel, the influence of different characteristics of the display panels can be reduced as much as possible by taking a mean value determined by the second voltage difference value of each display panel for which gamma debugging has been completed previously as a reference, so as to more accurately assign an initial voltage value to the second gray scale binding point of the subsequent display panel at the second brightness level.

Illustratively, the mean value of the second voltage difference values of the plurality of display panels may be a mean value of the respective second voltage difference values between the first brightness level and the second brightness level of the first display panel to the (N-1)th display panel at the first gray scale binding point.

After the gamma debugging of the second display panel is completed, each second voltage difference value between the first brightness level and the second brightness level of the second display panel at the first gray scale binding point can be obtained. Continuing with the example where the brightness levels comprise the brightness level 1 to the brightness level N₂ and the first gray scale binding point has a gray scale of 255, each second voltage difference value between the first brightness level and the second brightness level of the second display panel at the first gray scale binding point is stored as Gamma255Step2[i], where 1 ≤ i ≤ (N₁-1). Gamma255Step2[1] represents a second voltage difference value between the brightness level 1 and the brightness level 2 of the second display panel at the gray scale binding point 1, Gamma255Step2[2] represents a second voltage difference value between the brightness level 2 and the brightness level 3 of the second display panel at the gray scale binding point 1, and so on.

In step 183, the mean value of the second voltage difference values of the plurality of display panels may be calculated according to equation (2):

$$\begin{matrix}\text{Gamma255Step} \left[\text{i}\right] = \\ \frac{\text{Gamma255Step1} \left[\text{i}\right] + \text{Gamma255Step2} \left[\text{i}\right] + ⋯ + \text{Gamma255Step} \left(\text{N} - 1\right) \left[\text{i}\right]}{\text{N} - 1}\end{matrix} \qquad \text{(2)}$$

wherein Gamma255Step[i] represents the mean value of the second voltage difference values of the plurality of display panels, and Gamma255Step(N-1)[i] represents each second voltage difference value between the first brightness level and the second brightness level of the (N-1)th display panel at the first gray scale binding point.

In some optional embodiments, step 183 may specifically include: taking a difference between the voltage value corresponding to the first gray scale binding point of the Nth display panel at the first brightness level and the mean value of the second voltage difference values of the plurality of display panels as a fourth initial voltage value, to perform gamma debugging on the Nth display panel at the first gray scale binding point at the second brightness level, so as to determine an actual voltage value corresponding to the first gray scale binding point of the Nth display panel at the second brightness level. Illustratively, the actual voltage value corresponding to the first gray scale binding point of the Nth display panel at the second brightness level in step 183 may be determined in the manner described above for determining the actual voltage value corresponding to the first gray scale binding point of the first display panel at the first brightness level in step 111, which will not be described in detail herein. It can be understood that the actual brightness value at the actual voltage value corresponding to the first gray scale binding point of the Nth display panel at the second brightness level complies with the target brightness value corresponding to the first gray scale binding point of the Nth display panel at the second brightness level.

In order to better understand the present application, another example is given below. For example, the display panels to be debugged include a first display panel to a tenth display panel, and after performing gamma debugging on the first display panel and the second display panel, the mean value of the second voltage difference values of the first display panel and the second display panel can be determined according to the respective second voltage difference values between the first brightness level and the second brightness level of the first display panel and the second display panel at the first gray scale binding point, and then the mean value of the second voltage difference values determined from the first display panel and the second display panel is used to determine an initial voltage value corresponding to the first gray scale binding point of a third display panel at the second brightness level, to perform gamma debugging on the third display panel, and then an initial voltage value corresponding to the first gray scale binding point of a fourth display panel at the second brightness level is determined using the mean value of the second voltage difference values determined from the first display panel to the third display panel, to perform gamma debugging on the fourth display panel, and so on, the mean value of the second voltage difference values determined from the first display panel to the ninth display panel is used to determine an initial voltage value corresponding to the first gray scale binding point of the tenth display panel at the second brightness level, to perform gamma debugging on the tenth display panel. That is to say, when performing gamma debugging on the third display panel and display panels subsequent to the third display panel in sequence, the initial voltage values corresponding to the first gray scale binding point at the second brightness level are all determined according to the mean values of the second voltage difference values determined from previous display panels for which the debugging has been completed.

It will be appreciated that a display panel typically includes red, green and blue sub-pixels, and the method for gamma debugging described above may be performed on any of the sub-pixels. For red sub-pixels, for example, the voltage values or voltage difference values herein refer to voltage values or voltage difference values corresponding to the red sub-pixels, and the same applies to the green sub-pixels and the blue sub-pixels.

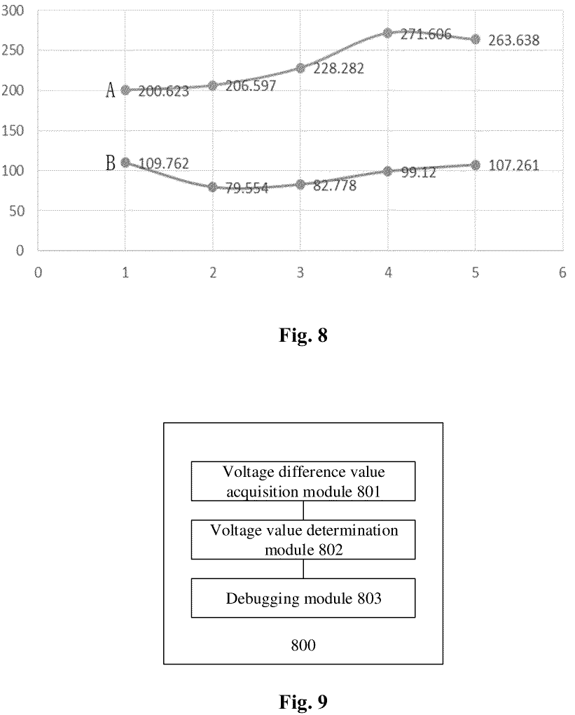

The inventors of the present application debug a display panel according to the method for gamma debugging provided in the embodiments of the present application, and debug the display panel according to a traditional method for gamma debugging where an initial voltage value is randomly set, so as to obtain a gamma debugging time comparison as shown in FIG. 8. In FIG. 8, the ordinate represents an actual debugging time, the abscissa represents different display panels, curve A represents the time required for debugging a display panel according to a conventional method for gamma debugging where an initial voltage value is randomly set, and curve B represents the time required for debugging the display panel according to the method for gamma debugging provided in the embodiments of the present application. It can be seen that, compared with the conventional method for gamma debugging, the method for gamma debugging provided in the embodiments of the present application can reduce the gamma debugging time by about 60%, so that the gamma debugging time can be greatly reduced and the production efficiency can be improved.

Embodiments of the present application also provide an apparatus for gamma debugging. As shown in FIG. 9, the apparatus for gamma debugging 800 provided by an embodiment of the present application comprises a voltage difference value acquisition module 801, a voltage value determination module 802 and a debugging module 803.

The voltage difference value acquisition module 801 is configured to acquire a first voltage difference value between a first gray scale binding point and a second gray scale binding point of a first display panel at a first brightness level.

The voltage value determination module 802 is configured to perform gamma debugging on a second display panel at the first brightness level, to determine a voltage value corresponding to the first gray scale binding point of the second display panel at the first brightness level.

The debugging module 803 is configured to take a difference between the voltage value corresponding to the first gray scale binding point of the second display panel at the first brightness level and the first voltage difference value as a first initial voltage value, to perform gamma debugging on the second display panel at the second gray scale binding point at the first brightness level.

According to the apparatus for gamma debugging according to the embodiments of the present application, a first voltage difference value between a first gray scale binding point and a second gray scale binding point of a first display panel is acquired first, and when performing gamma debugging on a second display panel at a first brightness level, it is only necessary to determine a voltage value corresponding to the first gray scale binding point of the second display panel at the first brightness level, and a difference between the voltage value corresponding to the first gray scale binding point of the second display panel at the first brightness level and the first voltage difference value is taken as a first initial voltage value, to perform gamma debugging on the second display panel at the second gray scale binding point at the first brightness level. The first initial voltage value is closer to an actual voltage value corresponding to the second gray scale binding point of the second display panel at the first brightness level, and with respect to randomly setting an initial voltage value corresponding to the second gray scale binding point of the second display panel at the first brightness level, an assignment value according to the first initial voltage value is more accurate, so that the number of times of performing gamma debugging on the second display panel at the second gray scale binding point at the first brightness level can be reduced, thereby reducing gamma debugging time and improving production efficiency.

In some optional embodiments, the voltage difference value acquisition module 801 is further configured to: acquire a second voltage difference value between the first brightness level and the second brightness level of the first display panel at the first gray scale binding point.

In some optional embodiments, the debugging module 803 is further configured to: take a difference between the voltage value corresponding to the first gray scale binding point of the second display panel at the first brightness level and the second voltage difference value as a second initial voltage value, to perform gamma debugging on the second display panel at the first gray scale binding point at the second brightness level.

In some optional embodiments, the voltage value determination module 802 is further configured to: perform gamma debugging on an Nth display panel at the first brightness level, to determine a voltage value of the Nth display panel at the first gray scale binding point, wherein N≥3 and N is an integer.

In some optional embodiments, the debugging module 803 is further configured to: take a difference between the voltage value corresponding to the first gray scale binding point of the Nth display panel at the first brightness level and a mean value of the first voltage difference values of a plurality of display panels as a third initial voltage value, to perform gamma debugging on the Nth display panel at the second gray scale binding point at the first brightness level.

In some optional embodiments, as shown in FIG. 9, the apparatus for gamma debugging provided by the embodiments of the present application further includes a mean value determination module 804 configured to: determine the mean value of the first voltage difference values based on respective first voltage difference values between the first gray scale binding point and the second gray scale binding point of the first display panel to a (N-1)th display panel at the first brightness level.

In some optional embodiments, the mean value determination module 804 is further configured to: determine a mean value of the second voltage difference values based on respective second voltage difference values between the first brightness level and the second brightness level of the first display panel to a (N-1)th display panel at the first gray scale binding point.

In some optional embodiments, the debugging module 803 is further configured to: take a difference between the voltage value corresponding to the first gray scale binding point of the Nth display panel at the first brightness level and the mean value of the second voltage difference values of a plurality of display panels as a fourth initial voltage value, to perform gamma debugging on the Nth display panel at the first gray scale binding point at the second brightness level.

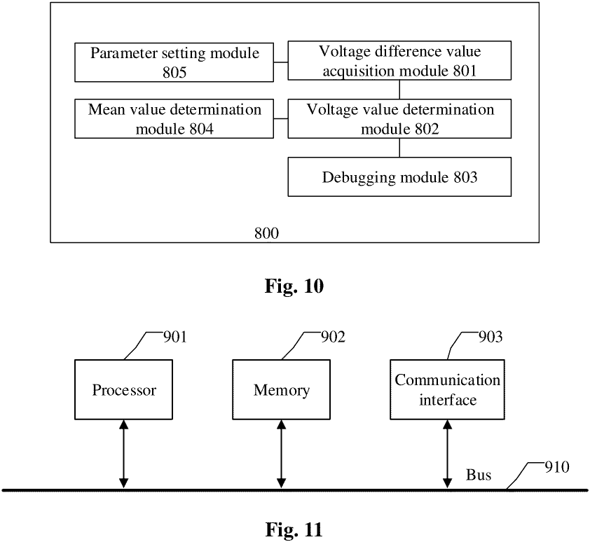

In some optional embodiments, as shown in FIG. 10, the apparatus for gamma debugging provided by embodiments of the present application further includes a parameter setting module 805 configured to: set a plurality of gray scale binding points, wherein the first gray scale binding point and the second gray scale binding point are two adjacent gray scale binding points of the plurality of gray scale binding points.

In some optional embodiments, the target brightness value corresponding to the first gray scale binding point is greater than the target brightness value corresponding to the second gray scale binding point at the same brightness level.

In some optional embodiments, the parameter setting module 805 is further configured to: set a plurality of brightness levels, wherein the first brightness level and the second brightness level are two adjacent brightness levels of the plurality of brightness levels.

In some optional embodiments, the target brightness value corresponding to the first brightness level is greater than the target brightness value corresponding to the second brightness level at the same gray scale binding point.

FIG. 11 illustrates a schematic diagram of a hardware structure of a device for gamma debugging according to an embodiment of the present application.

The device for gamma debugging may include a processor 901 and a memory 902 that stores computer program instructions.

In particular, the processor 901 described above may include a central processing unit (CPU), or an Application Specific Integrated Circuit (ASIC), or one or more integrated circuits that may be configured to implement embodiments of the present invention.

The memory 902 may include mass storage for data or instructions. By way of example, and not limitation, the memory 902 may include a Hard Disk Drive (HDD), a floppy disk drive, a flash memory, an optical disk, a magneto-optical disk, a magnetic tape, or a Universal Serial Bus (USB) drive, or a combination of two or more of the foregoing. Where appropriate, the memory 902 may include removable or non-removable (or fixed) media. Where appropriate, the memory 902 may be internal or external to an integrated gateway disaster tolerance device. In a particular embodiment, the memory 902 is a non-volatile solid-state memory. In a particular embodiment, the memory 902 includes a read only memory (ROM). Where appropriate, the ROM may be a mask programmed ROM, a programmable ROM (PROM), an erasable PROM (EPROM), an electrically erasable PROM (EEPROM), an electrically alterable ROM (EAROM) or a flash memory or a combination of two or more of the foregoing.

The processor 901 implements any of the method for gamma debugging in the above-described embodiments by reading and executing computer program instructions stored in the memory 902.

In one example, the device for gamma debugging may also include a communication interface 903 and a bus 910. As shown in FIG. 11, the processor 901, the memory 902 and the communication interface 903 are connected via the bus 910 and complete communication with each other.

The communication interface 903 is mainly configured for realizing communication between various modules, devices, units and/or devices in embodiments of the present invention.

The bus 910 includes hardware, software, or both to couple components of a compensation voltage determination device to one another. By way of example, and not limitation, the bus may include an Accelerated Graphics Port (AGP) or other graphics buses, an Enhanced Industry Standard Architecture (EISA) bus, a Front Side Bus (FSB), a HyperTransport (HT) interconnect, an Industry Standard Architecture (ISA) bus, an Infiniband interconnect, a Low Pin Count (LPC) bus, a memory bus, a Micro Channel Architecture (MCA) bus, a Peripheral Component Interconnect (PCI) bus, a PCI-Express (PCI-X) bus, a Serial Advanced Technology Attachment (SATA) bus, a Video Electronics Standards Association Local (VLB) bus, or other suitable buses, or a combination of two or more of the forgoing. The bus 910 may include one or more buses, as appropriate. Although embodiments of the present invention describe and illustrate a particular bus, the present invention contemplates any suitable bus or interconnect.

The device for gamma debugging may execute the method for gamma debugging in embodiments of the present application, thereby implementing the method for gamma debugging and the apparatus for gamma debugging described in conjunction with FIGS. 1 and 9.

Embodiments of the present application also provide a computer-readable storage medium having a computer program stored thereon, which when executed by a processor can implement the method for gamma debugging in the above-mentioned embodiments and achieve the same technical effect, and in order to avoid repetition, the description thereof will not be repeated here. The computer-readable storage medium may include a Read-Only Memory (ROM), a Random Access Memory (RAM), a magnetic disk or an optical disk, etc. which is not limited herein. Examples of the computer-readable storage medium include a non-transitory machine-readable medium such as an electronic circuit, a semiconductor memory device, a flash memory, an erasable ROM (EROM), a floppy disk, a CD-ROM, a hard disk, and the like.

In accordance with the embodiments of the present application as described herein, these embodiments do not describe all details in detail, nor do they limit the application to only the specific embodiments described. Obviously, many modifications and variations are possible in light of the above description. This description selects and specifically describes these embodiments in order to better explain the principles and practical applications of the present application, so that those skilled in the art can make good use of the present application and its modifications based on the present application. The present application is to be limited only by the claims, along with their full scope and equivalents.

What is claimed is:

1. A method for gamma debugging, comprising:
acquiring a first voltage difference value between a first gray scale binding point and a second gray scale binding point of a first display panel at a first brightness level;
performing gamma debugging on a second display panel at the first brightness level, to determine a voltage value corresponding to the first gray scale binding point of the second display panel at the first brightness level; and
taking a difference between the voltage value corresponding to the first gray scale binding point of the second display panel at the first brightness level and the first voltage difference value as a first initial voltage value, to perform gamma debugging on the second display panel at the second gray scale binding point at the first brightness level.

2. The method of claim 1, wherein the method further comprises:
acquiring a second voltage difference value between the first brightness level and a second brightness level of the first display panel at the first gray scale binding point; and
taking a difference between the voltage value corresponding to the first gray scale binding point of the second display panel at the first brightness level and the second voltage difference value as a second initial voltage value, to perform gamma debugging on the second display panel at the first gray scale binding point at the second brightness level.

3. The method of claim 2, wherein the method further comprises:
performing gamma debugging on an Nth display panel at the first brightness level, to determine a voltage value of the Nth display panel at the first gray scale binding point, wherein N≥3 and N is an integer; and
taking a difference between the voltage value corresponding to the first gray scale binding point of the Nth display panel at the first brightness level and a mean value of the first voltage difference values of a plurality of display panels as a third initial voltage value, to perform gamma debugging on the Nth display panel at the second gray scale binding point at the first brightness level.

4. The method of claim 3, wherein the method further comprises:
taking a difference between the voltage value corresponding to the first gray scale binding point of the Nth display panel at the first brightness level and a mean value of the second voltage difference values of a plurality of display panels as a fourth initial voltage value, to perform gamma debugging on the Nth display panel at the first gray scale binding point at the second brightness level.

5. The method of claim 1, wherein the method further comprises:
setting a plurality of gray scale binding points, wherein the first gray scale binding point and the second gray scale binding point are two adjacent gray scale binding points of the plurality of gray scale binding points.

6. The method of claim 5, wherein at a same brightness level, a target brightness value corresponding to the first gray scale binding point is greater than a target brightness value corresponding to the second gray scale binding point.

7. The method of claim 2, wherein the method further comprises:
setting a plurality of brightness levels, wherein the first brightness level and the second brightness level are two adjacent brightness levels of the plurality of brightness levels.

8. The method of claim 7, wherein at a same gray scale binding point, a target brightness value corresponding to the first brightness level is greater than a target brightness value corresponding to the second brightness level.

9. The method of claim 1, wherein the first display panel and the second display panel are display panels of a same batch.

10. The method of claim 1, wherein before the acquiring a first voltage difference value between a first gray scale binding point and a second gray scale binding point of a first display panel at a first brightness level, the method further comprises:
setting a fifth initial voltage value corresponding to the first gray scale binding point of the first display panel at the first brightness level and a sixth initial voltage value corresponding to the second gray scale binding point of the first display panel at the first brightness level;
determining whether an actual brightness of the first display panel at the fifth initial voltage value complies with a target brightness value corresponding to the first gray scale binding point of the first display panel at the first brightness level, and determining whether an actual brightness of the first display panel at the sixth initial voltage value complies with a target brightness value corresponding to the second gray scale binding point of the first display panel at the first brightness level;
if neither of them complies, adjusting the fifth initial voltage value and the sixth initial voltage value to obtain an adjusted fifth initial voltage value and an adjusted sixth initial voltage value, wherein an actual brightness of the first display panel at the adjusted fifth initial voltage value and an actual brightness of the first display panel the adjusted sixth initial voltage value comply with corresponding target brightness values respectively;
taking a difference value between the adjusted fifth initial voltage value and the adjusted sixth initial voltage value as the first voltage difference value.

11. The method of claim 2, wherein the method further comprises:
setting a plurality of brightness levels and a plurality of gray scale binding points;
performing gamma debugging on the first display panel in an order of gradually decreasing target brightness values corresponding to the brightness levels and gradually decreasing the gray scale binding points.

12. An apparatus for gamma debugging, comprising:
a voltage difference value acquisition module configured to acquire a first voltage difference value between a first gray scale binding point and a second gray scale binding point of a first display panel at a first brightness level;
a voltage value determination module configured to perform gamma debugging on a second display panel at the first brightness level, to determine a voltage value corresponding to the first gray scale binding point of the second display panel at the first brightness level;
a debugging module configured to take a difference between the voltage value corresponding to the first gray scale binding point of the second display panel at the first brightness level and the first voltage difference value as a first initial voltage value, to perform gamma debugging on the second display panel at the second gray scale binding point at the first brightness level.

13. The apparatus of claim 12, wherein the voltage value determination module is further configured to:
perform gamma debugging on an Nth display panel at the first brightness level, to determine a voltage value of the Nth display panel at the first gray scale binding point, wherein N≥3 and N is an integer;
the debugging module is further configured to:
take a difference between the voltage value corresponding to the first gray scale binding point of the Nth display panel at the first brightness level and a mean value of the first voltage difference values of a plurality of display panels as a third initial voltage value, to perform gamma debugging on the Nth display panel at the second gray scale binding point at the first brightness level.

14. The apparatus of claim 13, further comprising a mean value determination module configured to:
determine the mean value of the first voltage difference values based on respective first voltage difference values between the first gray scale binding point and the second gray scale binding point of the first display panel to a (N-1)th display panel at the first brightness level, or
determine a mean value of the second voltage difference values based on respective second voltage difference values between the first brightness level and a second brightness level of the first display panel to a (N-1)th display panel at the first gray scale binding point.

15. The apparatus of claim 14, wherein the debugging module is further configured to:
take a difference between the voltage value corresponding to the first gray scale binding point of the Nth display panel at the first brightness level and the mean value of the second voltage difference values of a plurality of display panels as a fourth initial voltage value, to perform gamma debugging on the Nth display panel at the first gray scale binding point at the second brightness level.

16. The apparatus of claim 12, further comprising a parameter setting module configured to:
set a plurality of gray scale binding points, wherein the first gray scale binding point and the second gray scale binding point are two adjacent gray scale binding points of the plurality of gray scale binding points, or
set a plurality of brightness levels, wherein the first brightness level and the second brightness level are two adjacent brightness levels of the plurality of brightness levels.

17. A device for gamma debugging, comprising a processor, a memory, and a computer program stored on the memory and executable on the processor, wherein the computer program, when executed by the processor, implements the method of claim 1.
